(19) United States
(12) Patent Application Publication
(10) Pub. No.: US 2026/0081511 A1
(43) Pub. Date: Mar. 19, 2026

(54) METHOD AND APPARATUS FOR CONTROLLING A DC/DC CONVERTER OF A BATTERY SYSTEM, AND COMPUTER PROGRAM PRODUCT

(71) Applicant: Robert Bosch GmbH, Stuttgart (DE)

(72) Inventor: Fanxi Hu, Wuxi (CN)

(21) Appl. No.: 19/327,510

(22) Filed: Sep. 12, 2025

(30) Foreign Application Priority Data
Sep. 14, 2024 (CN) 2024 1129 0694.7

(51) Int. Cl. H02M 1/00; H02J 7/00; H02M 3/158

(52) U.S. Cl. CPC H02M 1/0003; H02J 7/855; H02M 3/158

(57) ABSTRACT

A method for controlling a DC/DC converter of a battery system is disclosed. The method includes controlling the operating parameters of the DC/DC converter of the battery system based on the acquired stack current of the battery stack of the battery system, so as to regulate the phase current of the DC/DC converter. A first DC/DC conversion unit and a second DC/DC conversion unit are connected in parallel, in such a manner that: at least three operating intervals of the DC/DC converter are divided based on the acquired stack current of the battery stack, such that in each operating interval, the first DC/DC conversion unit and/or the second DC/DC conversion unit operate only in a single conduction mode, respectively. The conduction mode includes a continuous conduction mode and/or a discontinuous conduction mode. The method also includes, based on the conduction mode of the first DC/DC conversion unit and/or the second DC/DC conversion unit, selecting the first phase current of the first DC/DC conversion unit or the second phase current of the second DC/DC conversion unit as the AC injection current of the battery system.

This application claims priority under 35 U.S.C. § 119 to application no. CN 2024 1129 0694.7, filed on Sep. 14, 2024 in China, the disclosure of which is incorporated herein by reference in its entirety.

The present application relates to the field of batteries, and in particular, to a method for controlling a DC/DC converter of a battery system, an apparatus for controlling a DC/DC converter of a battery system, and a computer program product for at least assisting in implementing the steps of the method according to the present application.

### BACKGROUND

Fuel cells are highly efficient, environmentally friendly, and easy and flexible to assemble, but reliability is one of the key factors limiting their large-scale application. Electrochemical impedance spectroscopy (EIS) is an important manner of fault diagnosis in fuel cell systems. When measuring the electrochemical impedance spectrum of a fuel cell stack, an AC injection current is provided via the DC/DC converter, and the stack voltage response of the fuel cell stack is analyzed in the frequency domain. This enables the determination of the internal impedance of the fuel cell stack in the high-frequency domain, which can reflect the internal state of the fuel cell, including the water content of the proton exchange membrane, the content of liquid water at the cathode, the gas supply status, and so on.

To generate the AC injection current, the DC/DC converter may operate in continuous conduction mode (CCM), discontinuous conduction mode (DCM), and/or boundary conduction mode (BCM). Particularly, when the load current of the fuel cell changes, the DC/DC converter may switch between different conduction modes. This requires the control algorithm of the DC/DC converter to coordinate operation under different conduction modes and to address various issues arising from mode switching. The development of such control algorithms is extremely complex and incurs high technical overhead.

Therefore, how to avoid, as much as possible, mode switching of the DC/DC converter during the process of generating the AC injection current has become a technical challenge that needs to be addressed.

### SUMMARY

The purpose of the present application is to provide a method for controlling a DC/DC converter of a battery system, an apparatus for controlling a DC/DC converter of a battery system, and a computer program product for at least assisting in implementing the steps of the method according to the present application, so as to solve the problems in the prior art.

According to a first aspect of the present application, a method for controlling a DC/DC converter of a battery system is provided, the method comprising the steps of:
controlling the operating parameters of the DC/DC converter of the battery system based on the acquired stack current I_{S} of the battery stack of the battery system, so as to regulate the phase current of the DC/DC converter, wherein the DC/DC converter comprises a first DC/DC conversion unit and a second DC/DC conversion unit connected in parallel, in such a manner that: at least three operating intervals of the DC/DC converter are divided based on the acquired stack current I_{S} of the battery stack, such that in each operating interval, the first DC/DC conversion unit and/or the second DC/DC conversion unit operate only in a single conduction mode, respectively, wherein the conduction mode comprises a continuous conduction mode and/or a discontinuous conduction mode; and
based on the conduction mode of the first DC/DC conversion unit and/or the second DC/DC conversion unit, selecting the first phase current of the first DC/DC conversion unit or the second phase current of the second DC/DC conversion unit as the AC injection current of the battery system.

The core concept of the present application lies in: dividing at least three operating intervals of the DC/DC converter based on the acquired stack current I_{S}, such that in each operating interval, each DC/DC conversion unit operates only in a single conduction mode, so as to avoid the DC/DC converter entering a prohibited operating region where conduction mode switching may occur. At the same time, selecting the phase current of the DC/DC conversion unit as the AC injection current of the battery system based on the conduction mode of the DC/DC conversion unit, thereby avoiding, as much as possible, conduction mode switching in the DC/DC conversion unit used to provide the AC injection current. This effectively reduces the complexity and development cost of the control algorithm for the DC/DC converter.

According to a second aspect of the present application, an apparatus for controlling a DC/DC converter of a battery system is provided, the apparatus being configured to execute the method according to the present application, wherein the apparatus comprises the following components:
an acquisition module, configured to acquire the stack current I_{S} of the battery stack of the battery system;
a converter control module, configured to control the operating parameters of the DC/DC converter of the battery system based on the acquired stack current I_{S} of the battery stack of the battery system, so as to regulate the phase current of the DC/DC converter, wherein the DC/DC converter comprises a first DC/DC conversion unit and a second DC/DC conversion unit connected in parallel, in such a manner that: at least three operating intervals of the DC/DC converter are divided based on the acquired stack current I_{S} of the battery stack, such that in each operating interval, the first DC/DC conversion unit and/or the second DC/DC conversion unit operate only in a single conduction mode, respectively, wherein the conduction mode comprises a continuous conduction mode and/or a discontinuous conduction mode; and
a phase current selection module, configured to select, based on the conduction mode of the first DC/DC conversion unit and/or the second DC/DC conversion unit, the first phase current of the first DC/DC conversion unit or the second phase current of the second DC/DC conversion unit as the AC injection current of the battery system.

According to a third aspect of the present application, a computer program product, such as a computer-readable program carrier, is provided, comprising computer program instructions which, when executed by a processor, at least assist in implementing the steps of the method described in the present application.

### BRIEF DESCRIPTION OF DRAWINGS

In the following, the present application is described in greater detail with reference to the accompanying drawings to provide a better understanding of its principles, features, and advantages. The accompanying drawings include the following:

FIG. 1 is a schematic block diagram of a battery system according to one exemplary embodiment of the present application;

FIG. 2 is a flowchart illustrating a method for controlling a DC/DC converter of a battery system according to one exemplary embodiment of the present application;

FIG. 3 is a schematic diagram of a Boost topology of a DC/DC converter according to one exemplary embodiment of the present application;

FIG. 4 is a schematic diagram of a Buck topology of a DC/DC converter according to one exemplary embodiment of the present application;

FIG. 5 is a schematic diagram illustrating the operating intervals of the phase current of a DC/DC converter with a Boost topology according to one exemplary embodiment of the present application;

FIG. 6 is a schematic diagram illustrating the operating intervals of the phase current of a DC/DC converter with a Buck topology according to another exemplary embodiment of the present application;

FIG. 7 is a schematic diagram illustrating the operating intervals of the phase current of a DC/DC converter with a Boost topology according to another exemplary embodiment of the present application; and

FIG. 8 is a schematic block diagram of an apparatus for controlling a DC/DC converter of a battery system according to an exemplary embodiment of the present application.

### DETAILED DESCRIPTION

To provide a clearer understanding of the technical problems, technical solutions, and beneficial technical effects to be addressed by the present application, the following detailed description of the present application will be provided with reference to the accompanying drawings and multiple exemplary examples. It should be understood that the specific examples described herein are provided solely for the purpose of explaining the present application and not for limiting the scope of protection of the present application.

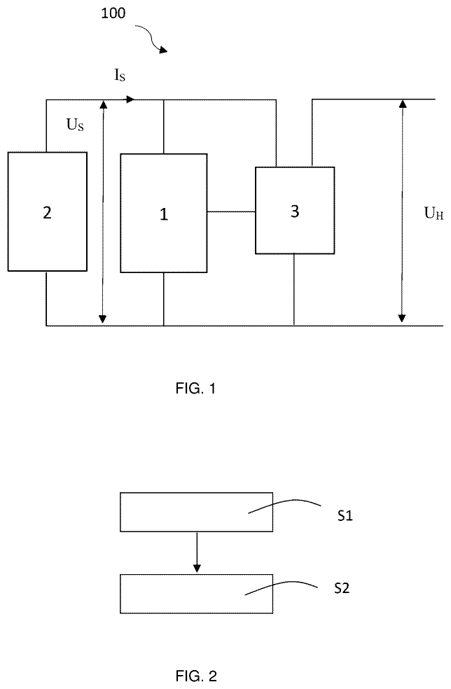

FIG. 1 is a schematic block diagram of a battery system 100 according to one exemplary embodiment of the present application. The battery system 100 may in particular be a fuel cell system, but may also be another type of battery system, such as a lithium battery system. The output voltage of the battery stack 2 (i.e., the stack voltage U_{S}) is converted by the DC/DC converter 3 into a high-voltage direct current (DC) voltage U_{H} and supplied to the high-voltage power supply network of the electric vehicle. The apparatus 1 is connected to the input side of the DC/DC converter 3 and is configured to control the DC/DC converter 3 of the battery system 100. Here, the acquisition module 11 of the apparatus 1 may acquire the stack current I_{S} of the battery stack 2, and optionally, may also acquire the stack voltage U_{S} of the battery stack 2 and/or the high-voltage DC voltage U_{H} of the high-voltage power supply network of the electric vehicle, among others.

FIG. 2 is a flowchart illustrating a method for controlling a DC/DC converter of a battery system according to one exemplary embodiment of the present application. The following exemplary embodiments describe the method according to the present application in greater detail.

As shown in FIG. 2, the method may comprise steps S1 and S2. In step S1, the operating parameters of the DC/DC converter 3 of the battery system 100 is controlled based on the acquired stack current I_{S} of the battery stack 2 of the battery system 100, so as to regulate the phase current of the DC/DC converter 3, wherein the DC/DC converter 3 comprises a first DC/DC conversion unit 31 and a second DC/DC conversion unit 32 connected in parallel, in such a manner that: based on the acquired stack current I_{S} of the battery stack 2, at least three operating intervals of the DC/DC converter 3 are defined, such that in each operating interval, the first DC/DC conversion unit 31 and/or the second DC/DC conversion unit 32 operate only in a single conduction mode, respectively.

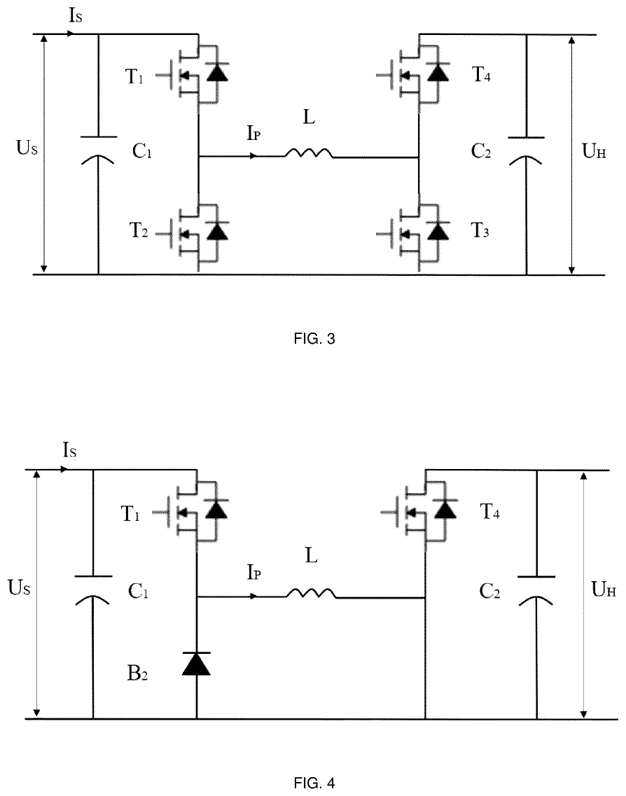

In the present embodiment of the application, the first DC/DC conversion unit 31 and the second DC/DC conversion unit 32 may, for example, be configured in a boost topology, buck topology, or buck-boost topology. FIG. 3 is a schematic diagram of a Boost topology of a DC/DC converter 3 according to one exemplary embodiment of the present application, which comprises an inductor L, a first filter capacitor C₁, a second filter capacitor C₂, a first semiconductor transistor T₁, a second semiconductor transistor T₂, a third semiconductor transistor T₃, and a fourth semiconductor transistor T₄, among others. These semiconductor transistors may, for example, be configured as silicon-controlled rectifiers (SCRs), metal-oxide-semiconductor field-effect transistors (MOSFETs), or insulated-gate bipolar transistors (IGBTs), etc. FIG. 4 is a schematic diagram of a Buck topology of a DC/DC converter 3 according to one exemplary embodiment of the present application, which comprises an inductor L, a first filter capacitor C₁, a second filter capacitor C₂, a first semiconductor transistor T₁, a rectifier diode B₂, and a fourth semiconductor transistor T₄, among others.

The driver circuit of the DC/DC converter 3 may control the on/off times of the respective semiconductor transistors according to the PWM voltage waveforms applied to each semiconductor transistor, thereby forming different conduction modes of the DC/DC converter 3. The conduction modes may include continuous conduction mode and/or discontinuous conduction mode, among others.

When the load current of the battery system 100 is relatively large-which means the stack current I_{S} is also large—the PWM voltage waveforms controlling the respective semiconductor transistors are typically complementary, so that a conductive path between the input voltage source and ground is continuously provided. The current flowing through the inductor of the DC/DC converter 3 during one switching cycle is always greater than zero. This conduction mode of the DC/DC converter 3 is referred to as continuous conduction mode (CCM). For example, in the continuous conduction mode of a DC/DC converter 3 with a buck topology, the average current flowing through the inductor of the DC/DC converter 3 can be calculated by the following Equation 1:

$${I}_{avg\_CCM} = \frac{1}{2} DT \frac{{U}_{S} - {U}_{H}}{L} + {I}_{offset} \qquad ( Equation 1 )$$

Where D represents the duty cycle of the switching signal of the DC/DC converter 3, T represents the period of the PWM signal, U_{S} represents the input voltage of the DC/DC converter 3 (i.e., the stack voltage of the battery stack 2), U_{H} represents the output voltage of the DC/DC converter 3 (i.e., the high-voltage DC voltage supplied to the high-voltage power supply network of the electric vehicle), L represents the inductance value of the DC/DC converter 3, and I_{offset} represents the offset current caused by the bias current of the semiconductor transistors and/or rectifier diodes.

When the load current of the battery system 100 is relatively small—which means the stack current I_{S} is also small—the PWM voltage waveforms controlling the respective semiconductor transistors are typically switching signals with relatively narrow pulse widths, so that each semiconductor transistor has a very short and constant conduction time. This results in the current flowing through the inductor of the DC/DC converter 3 being intermittent during one switching cycle, i.e., sometimes equal to zero and sometimes greater than zero. This conduction mode of the DC/DC converter 3 is referred to as discontinuous conduction mode (DCM). For example, in the discontinuous conduction mode of a DC/DC converter 3 with a buck topology, the average current flowing through the inductor of the DC/DC converter 3 can be calculated by the following Equation 2:

$${I}_{avg\_DCM} = \frac{1}{2} {D}^{2} T \frac{{U}_{S} ( {U}_{S} - {U}_{H} )}{{U}_{H} L} \qquad ( Equation 2 )$$

In existing control strategies for DC/DC converters, the phase current of one DC/DC conversion unit in the DC/DC converter is typically selected as the AC injection current of the battery system 100. This AC injection current can be used to calculate the electrochemical impedance spectrum of the battery stack 2. However, regardless of whether it is the first DC/DC conversion unit 31 or the second DC/DC conversion unit 32, the conduction mode in which it operates depends on the stack current I_{S} of the battery stack 2. In particular, when the load of the battery system 100 changes, the stack current I_{S} also changes. The phase current of the DC/DC conversion unit and the stack current I_{S} have corresponding mathematical relationships under different topologies of the DC/DC conversion unit (including boost topology, buck topology, and buck-boost topology). With changing stack current I_{S}, it is necessary to adjust the switching signal duty cycle of the DC/DC conversion unit so that the phase current of the DC/DC conversion unit satisfies the corresponding mathematical relationship with the stack current I_{S}. However, changes in the switching signal duty cycle may cause the DC/DC conversion unit to switch its conduction mode. Such conduction mode switching requires the control algorithm of the DC/DC converter to coordinate operation under different conduction modes and to address various technical issues caused by conduction mode switching. The development of such a control algorithm is extremely complex and technically demanding.

In the configuration scheme of the present application, it is possible to divide at least three operating intervals of the DC/DC converter 3 based on the acquired stack current I_{S} of the battery stack 2, such that in each operating interval, the first DC/DC conversion unit 31 and/or the second DC/DC conversion unit 32 each operate only in a single conduction mode, i.e., no switching of conduction modes occurs within each DC/DC conversion unit during any given operating interval.

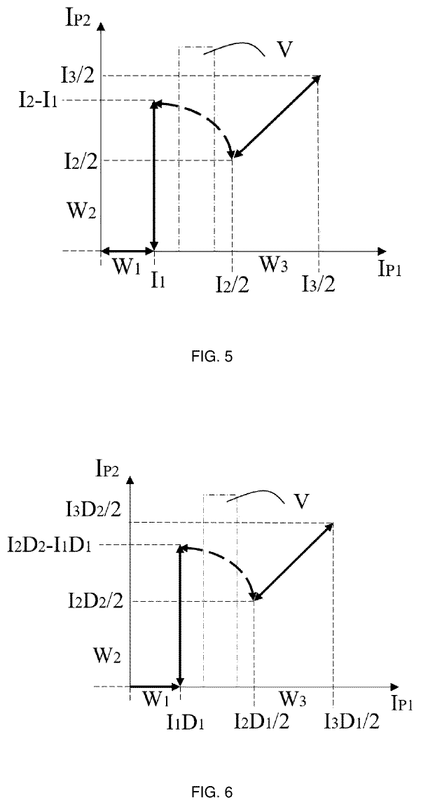

FIG. 5 is a schematic diagram illustrating the operating intervals of the phase current of a DC/DC converter with a Boost topology according to one exemplary embodiment of the present application; FIG. 6 is a schematic diagram illustrating the operating intervals of the phase current of a DC/DC converter with a Buck topology according to one exemplary embodiment of the present application. Considering that a DC/DC converter with a Buck-Boost topology may select operation in Boost mode or Buck mode based on the relationship between the input voltage and output voltage, a repeated description of the Buck-Boost topology in Boost or Buck mode is omitted here. As shown in FIGS. 5 and 6, based on the acquired stack current I_{S} of the battery stack 2, the operating interval of the DC/DC converter 3 may be divided into a first operating interval W₁, a second operating interval W₂, and a third operating interval W₃.

When the stack current I_{S} is less than or equal to a first preset current value I₁ (for example, 15 A), the DC/DC converter 3 operates in the first operating interval W₁. In the first operating interval W₁, the duty cycle D₁ of the first switching signal controlling the first DC/DC conversion unit 31 is regulated such that the first DC/DC conversion unit 31 always operates only in discontinuous conduction mode, while the second DC/DC conversion unit 32 remains in a deactivated state.

In the case where the first DC/DC conversion unit 31 is configured with a Boost topology, the duty cycle D₁ of the first switching signal for the first semiconductor switch T₁ and the third semiconductor switch T₃ of the first DC/DC conversion unit 31 is controlled such that, in the first operating interval W₁, the first phase current I_{P1} of the first DC/DC conversion unit 31 is equal to the stack current I_{S}. As shown in FIG. 5, the first operating interval W₁ is the operating region where the first phase current I_{P1} is in the range of 0 to I₁ and the second phase current I_{P2} is always zero.

In the case where the first DC/DC conversion unit 31 is configured with a Buck topology, the duty cycle D₁ of the first switching signal for the first semiconductor switch T₁ of the first DC/DC conversion unit 31 is controlled such that, in the first operating interval, the first phase current I_{P1} of the first DC/DC conversion unit 31 is equal to the product of the stack current I_{S} and the duty cycle D₁ of the first switching signal, i.e., I_{S}D₁. As shown in FIG. 6, the first operating interval W₁ is the operating region where the first phase current I_{P1} is in the range of 0 to I₁D₁ and the second phase current I_{P2} is always zero.

When the stack current I_{S} is greater than the first preset current value I₁ and less than the second preset current value I₂ (for example, 150 A), the DC/DC converter 3 operates in the second operating interval W₂. In the second operating interval W₂, the duty cycle D₁ of the first switching signal for the first DC/DC conversion unit 31 and the duty cycle D₂ of the second switching signal for the second DC/DC conversion unit 32 are controlled such that the first DC/DC conversion unit 31 operates only in discontinuous conduction mode, and the second DC/DC conversion unit 32 operates only in continuous conduction mode.

In the case where the DC/DC converter 3 is configured with a Boost topology, the duty cycle D₁ of the first switching signal for the first semiconductor switch T₁ and the third semiconductor switch T₃ of the first DC/DC conversion unit 31, as well as the duty cycle D₂ of the second switching signal for the first semiconductor switch T₁ and the third semiconductor switch T₃ of the second DC/DC conversion unit 32, are controlled such that, in the second operating interval W₂, the first phase current I_{P1} of the first DC/DC conversion unit 31 always remains equal to the first preset current value I₁, and the second phase current I_{P2} of the second DC/DC conversion unit 32 is equal to the difference between the stack current I_{S} and the first phase current I_{P1}, i.e., I_{S}−I_{P1}. As shown in FIG. 5, the second operating interval W₂ is the operating region where the first phase current I_{P1} is always equal to I₁ and the second phase current I_{P2} is in the range of 0 to I₂−I₁.

In the case where the first DC/DC conversion unit 31 is configured with a Buck topology, the duty cycle D₁ of the first switching signal for the first semiconductor switch T₁ of the first DC/DC conversion unit 31 and the duty cycle D₂ of the second switching signal for the first semiconductor switch T₁ of the second DC/DC conversion unit 32 are controlled such that, in the second operating interval W₂, the first phase current I_{P1} of the first DC/DC conversion unit 31 is equal to the product of the first preset current value I₁ and the duty cycle D₁ of the first switching signal, i.e., I₁D₁, and the second phase current I_{P2} is equal to the difference between the product of the stack current I_{S} and the duty cycle D₂ of the second switching signal and the product of the first phase current I_{P1} and the ratio of the duty cycle D₂ of the second switching signal to the duty cycle D₁ of the first switching signal, i.e., I_{S}D₂−I_{P1}D₂/D₁. As shown in FIG. 6, the second operating interval W₂ is the operating region where the first phase current I_{P1} is always equal to I₁D₁ and the second phase current I_{P2} is in the range of 0 to I₂D₂−I₁D₁.

When the stack current I_{S} is greater than or equal to the second preset current value I₂ and less than or equal to the third preset current value I₃ (for example, 600 A), the DC/DC converter 3 may operate in the third operating interval W₃. In the third operating interval W₃, the duty cycle D₁ of the first switching signal for the first DC/DC conversion unit 31 and the duty cycle D₂ of the second switching signal for the second DC/DC conversion unit 32 are controlled such that the first DC/DC conversion unit 31 and the second DC/DC conversion unit 32 each operate only in continuous conduction mode.

In the case where the DC/DC converter 3 is configured in a Boost topology, the first switching signal duty cycle D₁ for the first semiconductor switch T₁ and the third semiconductor switch T₃ of the first DC/DC conversion unit 31, as well as the second switching signal duty cycle D₂ for the first semiconductor switch T₁ and the third semiconductor switch T₃ of the second DC/DC conversion unit 32, are controlled such that, in the third operating interval W₃, both the first phase current I_{P1} of the first DC/DC conversion unit 31 and the second phase current I_{P2} of the second DC/DC conversion unit 32 are equal to half of the stack current I_{S}, i.e., Is/2. As shown in FIG. 5, the third operating interval W₃ is the operating region in which the first phase current I_{P1} is within the range of I₂/2 to I₃/2, and the second phase current I_{P2} is within the range of I₂/2 to I₃/2.

In the case where the DC/DC converter 3 is configured in a Buck topology, the first switching signal duty cycle D₁ for the first semiconductor switch T₁ of the first DC/DC conversion unit 31 and the second switching signal duty cycle D₂ for the first semiconductor switch T₁ of the second DC/DC conversion unit 32 are controlled such that, in the third operating interval W₃, the first phase current I_{P1} of the first DC/DC conversion unit 31 is equal to half of the stack current I_{S} multiplied by the first switching signal duty cycle D₁, i.e., I_{P1}D₁/2, and the second phase current I_{P2} of the second DC/DC conversion unit 32 is equal to half of the stack current I_{S} multiplied by the second switching signal duty cycle D₂, i.e., I_{S}D₂/2. As shown in FIG. 6, the third operating interval W₃ is the operating region in which the first phase current I_{P1} is within the range of I₂D₁/2 to I₃D₁/2, and the second phase current I_{P2} is within the range of I₂D₂/2 to I₃D₂/2.

As shown in FIGS. 5 and 6, the process of switching from the second operating region W₂ to the third operating region W₃ may be represented by the operation indicated by the dashed arrows. As the stack current I_{S} increases beyond 12, both the first phase current I_{P1} and the second phase current I_{P2} undergo a sudden change in current value, which is indicated by the dashed arrows. In this way, the DC/DC converter 3 can bypass the prohibited operating region V surrounded by the dash-dot line. In the prohibited operating region V, each DC/DC conversion unit may undergo conduction mode switching as the stack current I_{S} varies. Such conduction mode switching requires the control algorithm of the DC/DC converter to coordinate operation in different conduction modes and to address various technical issues arising from conduction mode switching, making the development of such a control algorithm extremely complex and technically demanding. By dividing the operating regions as described in this application, the DC/DC converter 3 is effectively prevented from operating in the prohibited region V, thereby simplifying the control algorithm of the DC/DC converter.

In the first operating interval W₁, the first DC/DC conversion unit 31 operates only in the discontinuous conduction mode, and the second DC/DC conversion unit 32 is in a deactivated state. In the second operating interval W₂, the first DC/DC conversion unit 31 operates only in the discontinuous conduction mode, and the second DC/DC conversion unit 32 operates only in the continuous conduction mode. This means that when the stack current I_{S} changes at the critical value I₁ between these two operating intervals, frequent switching of the conduction modes of the first DC/DC conversion unit 31 and the second DC/DC conversion unit 32 may occur. To avoid frequent switching of the conduction modes of each DC/DC conversion unit at the critical value between the first operating interval W₁ and the second operating interval W₂, a hysteresis region may be introduced at the critical value between these two operating intervals.

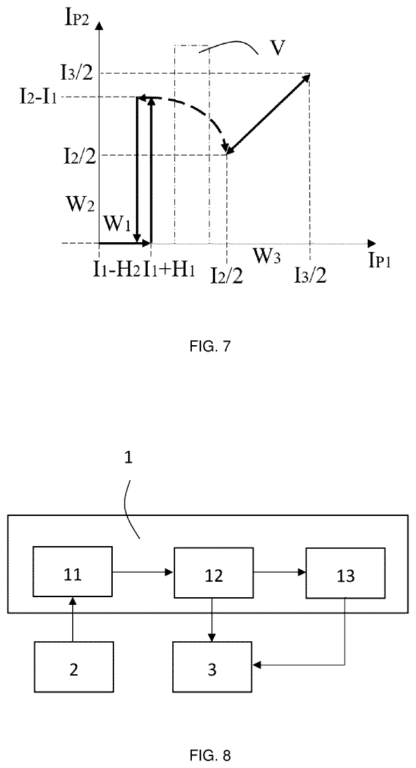

As shown in FIG. 7, which is a schematic diagram of the operating intervals of the phase current of a DC/DC converter with a Boost topology according to another exemplary embodiment of this application, the hysteresis region is the operating region in which the first phase current I_{P1} is within the range of I₁−H₂ to I₁+H₁, and the second phase current I_{P2} is within the range of 0 to I₂−I₁. When the stack current I_{S} increases, and the stack current I_{S} is less than or equal to the sum of the first preset current value I₁ and the first hysteresis threshold H₁, i.e., I₁+H₁, the DC/DC converter 3 operates in the first operating interval W₁. In the first operating interval W₁, the first switching signal duty cycle D₁ of the first DC/DC conversion unit 31 is controlled such that the first DC/DC conversion unit 31 operates only in the discontinuous conduction mode, and the second DC/DC conversion unit 32 is in a deactivated state.

When the stack current I_{S} decreases, and the stack current I_{S} is greater than the difference between the first preset current value I₁ and the second hysteresis threshold H₂, i.e., I₁−H₂, and less than the second preset current value I₂, the DC/DC converter 3 operates in the second operating interval W₂. In the second operating interval W₂, the first switching signal duty cycle D₁ of the first DC/DC conversion unit 31 and the second switching signal duty cycle D₂ of the second DC/DC conversion unit 32 are controlled such that the first DC/DC conversion unit 31 operates only in the discontinuous conduction mode, and the second DC/DC conversion unit 32 operates only in the continuous conduction mode.

In step S2, based on the conduction mode of the first DC/DC conversion unit 31 and/or the second DC/DC conversion unit 32, the first phase current of the first DC/DC conversion unit 31 or the second phase current of the second DC/DC conversion unit 32 is selected as the AC injection current of the battery system 100.

In the first operating interval W₁ and/or the second operating interval W₂, the first phase current I_{P1} of the first DC/DC conversion unit 31 operating in the discontinuous conduction mode may be selected as the AC injection current of the battery system 100, thereby ensuring that the first DC/DC conversion unit providing the AC injection current does not undergo conduction mode switching in these two operating intervals. In the third operating interval W₃, either the first phase current I_{P1} of the first DC/DC conversion unit 31 operating in the continuous conduction mode or the second phase current I_{P2} of the second DC/DC conversion unit 32 operating in the continuous conduction mode may be selected as the AC injection current of the battery system 100, i.e., any fixed DC/DC conversion unit may be selected to provide the AC injection current. The AC injection current may be used to calculate the electrochemical impedance spectrum of the battery stack 2.

It should be noted that, in the above embodiments, the first DC/DC conversion unit 31 and the second DC/DC conversion unit 32 may be interchanged, and a repeated description is omitted here.

According to the embodiments of the present application, at least three operating intervals of the DC/DC converter are divided based on the acquired stack current I_{S}, such that in each operating interval, each DC/DC conversion unit operates only in a single conduction mode, so as to avoid the DC/DC converter entering a prohibited operating region where conduction mode switching may occur. At the same time, selecting the phase current of the DC/DC conversion unit as the AC injection current of the battery system based on the conduction mode of the DC/DC conversion unit, thereby avoiding, as much as possible, conduction mode switching in the DC/DC conversion unit used to provide the AC injection current. This effectively reduces the complexity and development cost of the control algorithm for the DC/DC converter.

In addition, it should be noted that the step numbers described herein do not necessarily represent a sequential order, but are merely for reference purposes. The order may be changed as appropriate, provided that the technical objectives of the present application can be achieved.

FIG. 8 is a schematic block diagram of an apparatus 1 for controlling a DC/DC converter of a battery system according to an exemplary embodiment of the present application.

As shown in FIG. 8, the apparatus 1 may include the following components:
An acquisition module 11, configured to acquire the stack current I_{S} of the battery stack 2 of the battery system 100, and optionally, to acquire the stack voltage U_{S} of the battery stack 2 and/or the high-voltage DC voltage U_{H} of the high-voltage power supply network of the electric vehicle, among others. The acquisition module 11, for example, comprises a current sensor and, optionally, a voltage sensor;
a converter control module 12, configured to control the operating parameters of the DC/DC converter 3 of the battery system 100 based on the acquired stack current I_{S} of the battery stack 2 of the battery system 100, so as to regulate the phase current of the DC/DC converter 3, wherein the DC/DC converter 3 comprises a first DC/DC conversion unit 31 and a second DC/DC conversion unit 32 connected in parallel, in such a manner that: at least three operating intervals of the DC/DC converter 3 are divided based on the acquired stack current I_{S} of the battery stack 2, such that in each operating interval, the first DC/DC conversion unit 31 and/or the second DC/DC conversion unit 32 operate only in a single conduction mode, respectively, wherein the conduction mode comprises a continuous conduction mode and/or a discontinuous conduction mode; and
a phase current selection module 13, configured to select, based on the conduction mode of the first DC/DC conversion unit 31 and/or the second DC/DC conversion unit 32, the first phase current of the first DC/DC conversion unit 31 or the second phase current of the second DC/DC conversion unit 32 as the AC injection current of the battery system 100.

In addition, it should be understood that in this document, terms such as “first,” “second,” “third,” etc., are used for descriptive purposes only and should not be construed as indicating or implying relative importance. Furthermore, such terms should not be understood as implying a specific quantity of the indicated technical features.

If an embodiment includes an “and/or” relationship between a first feature and a second feature, it should be interpreted as follows: According to one embodiment, the embodiment comprises both the first feature and the second feature; according to another embodiment, the embodiment comprises either only the first feature or only the second feature. Although specific embodiments have been described above, these embodiments are not intended to limit the scope of the present disclosure, even in cases where only a single embodiment is described with respect to a particular feature. The examples of features provided in the present disclosure are intended for illustrative purposes only and are not limiting, unless otherwise stated. In a specific implementation, multiple features may be combined with one another as per actual requirements and when technically feasible. Various substitutions, modifications, and alterations may be conceived without departing from the spirit and scope of the present application.

What is claimed is:

1. A method for controlling a DC/DC converter of a battery system, comprising:
controlling operating parameters of the DC/DC converter of the battery system based on an acquired stack current of the battery stack of the battery system so as to regulate phase current of the DC/DC converter, wherein the DC/DC converter includes a first DC/DC conversion unit and a second DC/DC conversion unit connected in parallel in such a manner that at least three operating intervals of the DC/DC converter are divided based on the acquired stack current of the battery stack such that in each operating interval the first DC/DC conversion unit and/or the second DC/DC conversion unit operate only in a single conduction mode, respectively, wherein the conduction mode includes a continuous conduction mode and/or a discontinuous conduction mode; and
based on the conduction mode of the first DC/DC conversion unit and/or the second DC/DC conversion unit, selecting a first phase current of the first DC/DC conversion unit or a second phase current of the second DC/DC conversion unit as the AC injection current of the battery system.

2. The method according to claim 1, wherein, when the stack current is less than or equal to a first preset current value, the DC/DC converter operates in a first operating interval in which the duty cycle of the first switching signal of the first DC/DC conversion unit is controlled such that the first DC/DC conversion unit operates only in the discontinuous conduction mode, and the second DC/DC conversion unit is in a deactivated state.

3. The method according to claim 2, wherein, when the stack current is greater than the first preset current value and less than a second preset current value, the DC/DC converter operates in a second operating interval in which the duty cycle of the first switching signal of the first DC/DC conversion unit and the duty cycle of the second switching signal of the second DC/DC conversion unit are controlled such that the first DC/DC conversion unit operates only in the discontinuous conduction mode, and the second DC/DC conversion unit operates only in the continuous conduction mode.

4. The method according to claim 1, wherein, when the stack current increases and is less than or equal to the sum of the first preset current value and a first hysteresis threshold, the DC/DC converter operates in the first operating interval in which the duty cycle of the first switching signal of the first DC/DC conversion unit is controlled such that the first DC/DC conversion unit operates only in the discontinuous conduction mode, and the second DC/DC conversion unit is in a deactivated state.

5. The method according to claim 4, wherein, when the stack current decreases and is greater than the difference between the first preset current value and a second hysteresis threshold, and less than the second preset current value, the DC/DC converter operates in the second operating interval in which the duty cycle of the first switching signal of the first DC/DC conversion unit and the duty cycle of the second switching signal of the second DC/DC conversion unit are controlled such that the first DC/DC conversion unit operates only in the discontinuous conduction mode and the second DC/DC conversion unit operates only in the continuous conduction mode.

6. The method according to claim 2, wherein, in the first operating interval and/or the second operating interval, the first phase current of the first DC/DC conversion unit operating in the discontinuous conduction mode is selected as the AC injection current of the battery system.

7. The method according to claim 2, wherein, when the stack current is greater than or equal to the second preset current value and less than or equal to a third preset current value, the DC/DC converter operates in a third operating interval in which the duty cycle of the first switching signal of the first DC/DC conversion unit and the duty cycle of the second switching signal of the second DC/DC conversion unit are controlled such that the first DC/DC conversion unit and the second DC/DC conversion unit operate only in the continuous conduction mode, respectively.

8. The method according to claim 7, wherein, in the third operating interval, the first phase current of the first DC/DC conversion unit operating in the continuous conduction mode or the second phase current of the second DC/DC conversion unit operating in the continuous conduction mode is selected as the AC injection current of the battery system.

9. An apparatus for controlling a DC/DC converter of a battery system, the apparatus being configured to perform the method according to claim 1, wherein the apparatus comprises:
an acquisition module configured to acquire the stack current of the battery stack of the battery system;
a converter control module configured to control the operating parameters of the DC/DC converter of the battery system based on the acquired stack current of the battery stack of the battery system so as to regulate the phase current of the DC/DC converter, wherein the DC/DC converter comprises a first DC/DC conversion unit and a second DC/DC conversion unit connected in parallel in such a manner that at least three operating intervals of the DC/DC converter are divided based on the acquired stack current of the battery stack such that in each operating interval the first DC/DC conversion unit and/or the second DC/DC conversion unit operate only in a single conduction mode, respectively, wherein the conduction mode comprises a continuous conduction mode and/or a discontinuous conduction mode; and
a phase current selection module configured to select, based on the conduction mode of the first DC/DC conversion unit and/or the second DC/DC conversion unit, the first phase current of the first DC/DC conversion unit or the second phase current of the second DC/DC conversion unit as the AC injection current of the battery system.

10. A computer program product, comprising computer program instructions, wherein the computer program instructions, when executed by a processor, at least assist in implementing the steps of the method according to claim 1.

11. The computer program product according to claim 10, wherein the computer program product is a computer-readable program carrier.
